(19) United States
(12) Patent Application Publication
(10) Pub. No.: US 2025/0073801 A1
(43) Pub. Date: Mar. 6, 2025

(54) Portable Electric Soldering Iron Tool

(71) Applicants: Jingrong Ye, Hangzhou (CN); Genzhang Ye, JINHUA CITY (CN)

(72) Inventor: Genzhang Ye, JINHUA CITY (CN)

(21) Appl. No.: 18/241,242

(22) Filed: Sep. 1, 2023

(51) Int. Cl. B23K 3/03

(52) U.S. Cl. CPC B23K 3/0323; B23K 3/0307

(57) ABSTRACT

A portable electric soldering iron tool includes a heating assembly, a control assembly and a housing handle. The heating assembly includes a soldering sleeve and a heater element disposed in the soldering sleeve, wherein the heater element includes a substrate and at least a thick film layer provided on the substrate, the control assembly includes a controller and a power module electrically connected to the controller, the thick film layer of the heater element is electrically connected to the controller, the heating assembly and the control assembly are assembled to the housing handle.

### BACKGROUND OF THE PRESENT INVENTION

### Field of Invention

The present invention relates to an instrument for melting solder, and more particularly to a portable electric soldering iron tool comprising a heating assembly that can be heated to a working temperature within a few seconds.

### Description of Related Arts

A soldering iron is a device used for attaching wires and electronic components with solder. Referring to FIG. 1 of the drawings, a typical conventional soldering iron is illustrated to comprise a handle 1, a soldering tip 2 mounted to the handle 1, and a heating member disposed in the soldering tip 2 for heating the soldering tip 2. The heating member may be a thermal pulse core, a ceramic heating core or a DC heating core. However, the heating efficiency of the heating member is not satisfied that it requires dozens of seconds for heating the soldering tip 2 to its working temperature.

In addition, one or more buttons are provided on the handle 2 for the user to press, so as to control the operation of the conventional soldering iron. However, there is risk that the buttons are mistakenly touched that the soldering iron is activated and may result in safety hazard.

### SUMMARY OF THE PRESENT INVENTION

The invention is advantageous in that it provides a portable electric soldering iron tool which comprises a heating assembly that can be quickly heated to a working temperature.

Another advantage of the present invention is to provide a portable electric soldering iron tool, wherein the heating assembly comprises a heater element which comprises a thick film circuit layer which has a relatively low electric resistance, so that the heater element can be quickly heated to the working temperature.

Another advantage of the present invention is to provide a portable electric soldering iron tool, wherein the heating assembly comprises a soldering sleeve, and the heater element is disposed in the soldering sleeve for quickly heating the soldering sleeve, so as to allow the soldering sleeve to get ready for soldering within a few seconds.

Another advantage of the present invention is to provide a portable electric soldering iron tool, wherein the heater element is extended into a closed end of the soldering sleeve, so that the closed end of the soldering sleeve, which is used for melting and joining metal elements can be directly heated by the heater element, so as to reduce the time for getting ready of the soldering sleeve.

Another advantage of the present invention is to provide a portable electric soldering iron tool, wherein the heater element is received in the soldering sleeve in such a manner that the heater element is shaped and sized to couple with the soldering sleeve, so that the soldering sleeve is heated by the heater element quickly.

Another advantage of the present invention is to provide a portable electric soldering iron tool, wherein the thick film circuit layer of the heater element is firmly attached to an inner surface of the soldering sleeve, so as to allow the heat to be quickly and efficiently transferred from the heater element to the soldering sleeve.

Another advantage of the present invention is to provide a portable electric soldering iron tool, wherein the actuator for being pushed to slide, so as to actuate the heating operation of the heater element is retained in position by a retaining portion of a cap assembly, so that the risk of accidentally actuating the heater element is avoided, so as to ensure the safety use of the portable electric soldering iron tool.

Another advantage of the present invention is to provide a portable electric soldering iron tool which is incorporated with accessories such as a soldering coil material and a magnifying glass, so as to facilitate the use of the portable electric soldering iron tool.

Another advantage of the present invention is to provide a portable electric soldering iron tool which comprises a housing handle which is shaped like a pen that is easy and conventional for a user to grip thereon to manipulate.

Additional advantages and features of the invention will become apparent from the description which follows, and may be realized by means of the instrumentalities and combinations particularly pointing out in the appended claims.

According to the present invention, the foregoing and other objects and advantages are attained by a portable electric soldering iron tool, comprising:
a heating assembly which comprises a soldering sleeve and a heater element disposed in the soldering sleeve, wherein the heater element comprises a substrate and at least a thick film layer provided on the substrate;
a control assembly which comprises a controller and a power module electrically connected to the controller, wherein the thick film layer of the heater element is electrically connected to the controller; and
a housing handle, wherein the heating assembly and the control assembly are assembled to the housing handle.

According to an embodiment of the present invention, the substrate comprise an attaching surface, wherein the soldering sleeve comprises an inner heat transferring surface which is shaped and sized to couple with the attaching surface of the substrate, so as to allow the thick film layer sandwiched between the attaching surface of the substrate and the inner heat transferring surface of the soldering sleeve to have a firmly contact with the soldering sleeve.

According to an embodiment of the present invention, the attaching surface of the substrate is an arc surface, wherein the inner heat transferring surface of the soldering sleeve is an arc surface which is shaped and sized to couple with the attaching surface of the substrate.

According to an embodiment of the present invention, the attaching surface of the substrate is a plane surface, wherein the inner heat transferring surface of the soldering sleeve is a plane surface which is shaped and sized to couple with the attaching surface of the substrate.

According to an embodiment of the present invention, the heater element comprises two the thick film layers provided on two sides of the substrate.

According to an embodiment of the present invention, the substrate comprise two attaching surfaces which are opposite to each other, wherein the soldering sleeve comprises two inner heat transferring surfaces which are respectively shaped and sized to couple with the two attaching surfaces of the substrate.

According to an embodiment of the present invention, the heater element further comprises two electrode connecting members electrically connecting the thick film layer to the controller, each of two the thick film layers comprises two electrode portions electrically connected to the two electrode connecting members respectively, one or more heating portions connected to the two electrode portions.

According to an embodiment of the present invention, each of two the thick film layers comprises an inner heating portion and an outer heating portion which are respectively connected to the two electrode portions and are arranged in a parallel connection manner.

According to an embodiment of the present invention, each of two the inner heating portion and the outer heating portion comprises two tip end portions and two extending portions, wherein the two tip end portions, which are respectively extended from the two extending portions, are joined to form a tip end.

According to an embodiment of the present invention, said soldering sleeve comprises an opening end and a closed end, wherein the heater element is inserted into the soldering sleeve through the opening end, wherein the thick film layer is inserted to a position corresponding to the closed end of the soldering sleeve.

According to an embodiment of the present invention, the control assembly comprises an actuator which comprises a driving member and a switch member, wherein the housing handle has a sliding groove, wherein the driving member is disposed at the sliding groove, wherein the driving member is arranged to be operated to slide along the sliding groove to drive the switch member to switch on or switch off an electrical connection between the controller and the heater element.

According to an embodiment of the present invention, the portable electric soldering iron tool further comprises a cap assembly detachably mounted to the housing handle, wherein the cap assembly comprises a retaining member which is arranged to block sliding movement of the driving member of the actuator when the cap assembly is assembled to the housing handle, wherein when the cap assembly is detached from the housing handle, the sliding movement of the actuator is allowed.

According to an embodiment of the present invention, the cap assembly comprises a cap protector and an auxiliary cap, wherein the cap protector is detachably mounted to the housing handle, the auxiliary cap is detachably mounted to the cap protector, wherein the retaining member is connected to one of the cap protector and the auxiliary cap.

According to an embodiment of the present invention, the cap protector comprises a protector mount which is detachably mounted to the housing handle and a cap member connected to the protector mount to receive the heating assembly.

According to an embodiment of the present invention, a magnifying glass is connected to one of the cap protector and the auxiliary cap.

According to an embodiment of the present invention, a soldering coil material is detachably connected to the auxiliary cap.

According to an embodiment of the present invention, the housing handle comprises a handle body for receiving the controller, a mounting element assembled to the handle body for mounting the heating assembly.

According to an embodiment of the present invention, the mounting element comprises a mounting portion mounted to the handle body and a retaining tube connected to the mounting portion to mount the soldering sleeve in position, wherein the soldering sleeve comprises an opening end and a closed end, wherein the opening end of the soldering sleeve is retained in the retaining tube, the closed end of the soldering sleeve is extended at an outer side of the retaining tube.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional soldering iron.

FIG. 2 is a perspective view of a portable electric soldering iron tool according to a preferred embodiment of the present invention.

FIG. 3 is another perspective view of the portable electric soldering iron tool according to the above preferred embodiment of the present invention.

FIG. 4 is a sectional view of the portable electric soldering iron tool according to the above preferred embodiment of the present invention.

FIG. 5 is a perspective view of the portable electric soldering iron tool win exposed soldering sleeve according to the above preferred embodiment of the present invention.

FIG. 6 is an exploded view of the portable electric soldering iron tool according to the above preferred embodiment of the present invention.

FIG. 7 is another exploded view of the portable electric soldering iron tool according to the above preferred embodiment of the present invention.

FIG. 8 is a perspective view of a heating assembly of the portable electric soldering iron tool according to the above preferred embodiment of the present invention.

FIG. 9 is another perspective view of the heating assembly of the portable electric soldering iron tool according to the above preferred embodiment of the present invention.

FIG. 10 is an exploded view of the heating assembly of the portable electric soldering iron tool according to the above preferred embodiment of the present invention.

FIG. 11 is another exploded view of the heating assembly of the portable electric soldering iron tool according to the above preferred embodiment of the present invention.

FIG. 12 is a sectional view of the heating assembly of the portable electric soldering iron tool according to the above preferred embodiment of the present invention.

FIG. 13 is an exploded view of a portable electric soldering iron tool according to an alternative mode of the above preferred embodiment of the present invention.

FIG. 14 is an enlarged perspective view of a heating assembly of the portable electric soldering iron tool according to the alternative mode of the above preferred embodiment of the present invention.

FIG. 15 is a sectional view of the heating assembly of the portable electric soldering iron tool according to the alternative mode of the above preferred embodiment of the present invention.

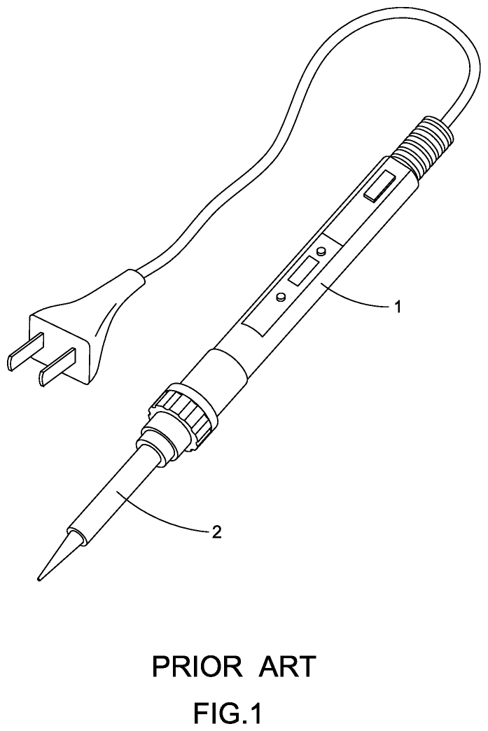

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

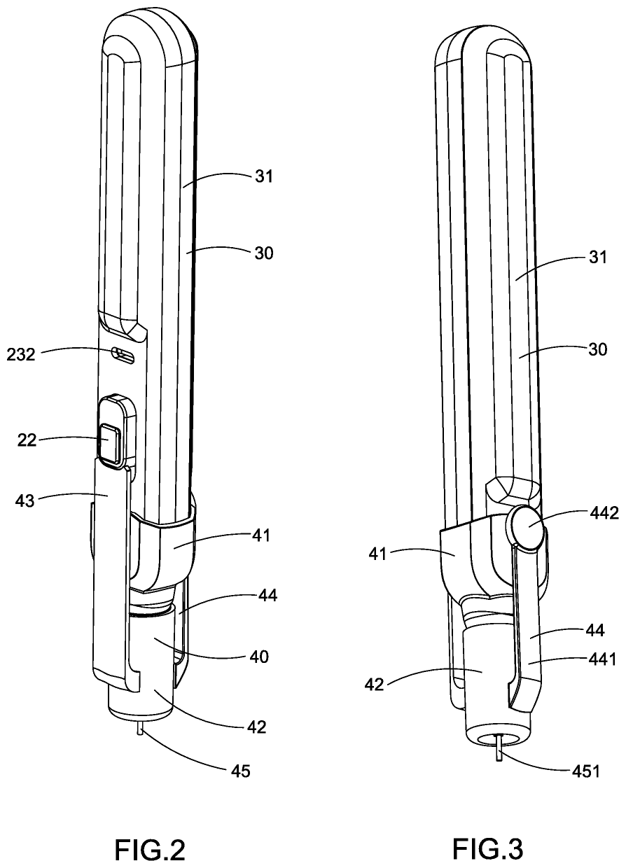

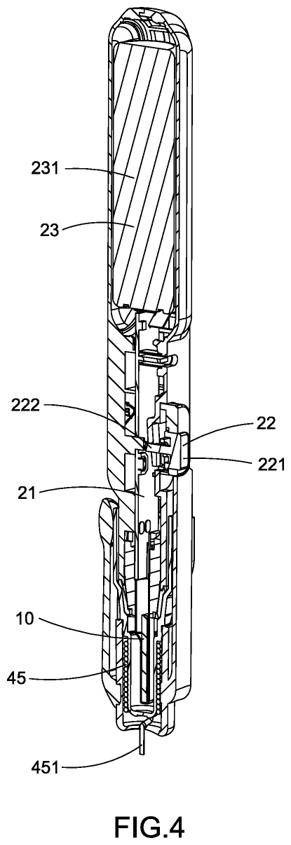

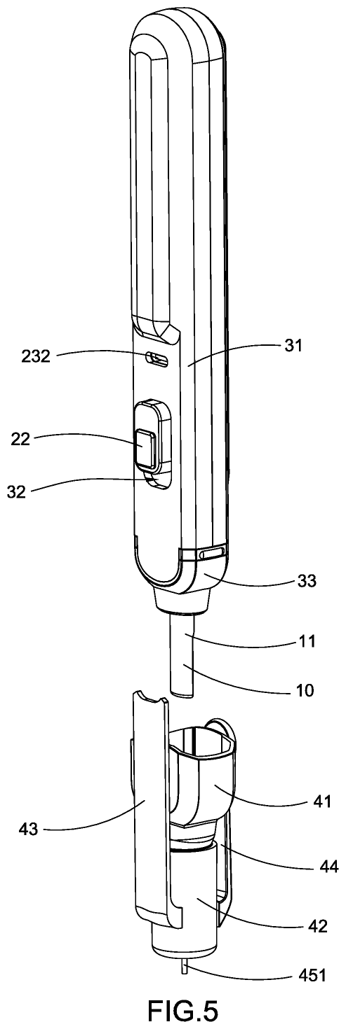

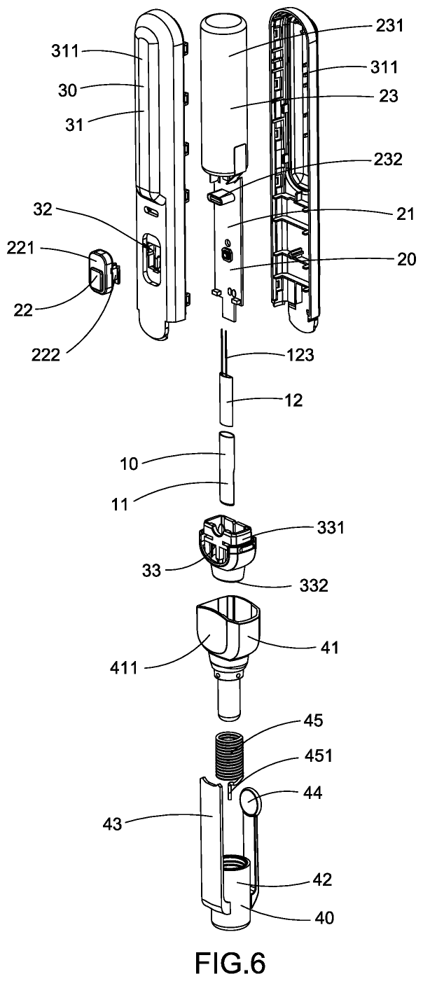

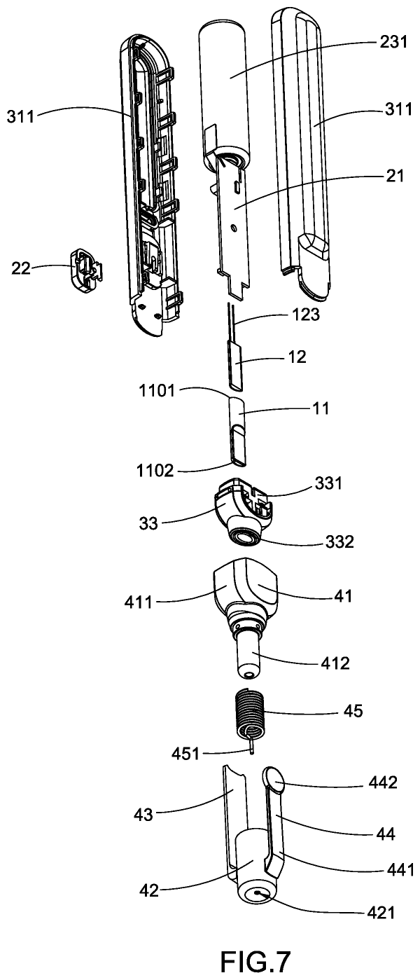

Referring to FIG. 2 to FIG. 12 of the drawings, a portable electric soldering iron tool according to a first preferred embodiment of the present invention is illustrated. The portable electric soldering iron tool comprises a heating assembly 10, a control assembly 20 and a housing handle 30. The heating assembly 10 and the control assembly 20 are assembled to the housing handle 30 for being activated for soldering metal materials, so that the metal materials are melted and joined together.

More specifically, the heating assembly 10 comprises a soldering sleeve 11 and a heater element 12 which is disposed in the soldering sleeve 11 for heating the soldering sleeve 11. The control assembly 20 comprises a controller 21 and an actuator 22 electrically connected to the controller 21 for being operated to switch on or switch off the electrical connection between the controller 21 and the heater element 12. The control assembly 20 further comprises a power module 23 which is electrically connected to the controller 21 for supplying electricity to the controller 21.

Accordingly, when the controller 21, which is embodied to comprise a circuit board, is electrically connected to the heater element 12, the heater element 12 is in operation to heat the soldering sleeve 21 under control of the controller 21 which is supplied with electric power by the power module 23.

The power module 23 may be embodied to comprise a rechargeable battery 231 and an electrically charging interface 232 for being electrically connected to an external power source for electrically charging the rechargeable battery 231 which can be lead-acid battery, Ni—Cd battery, Ni-MH battery, or Li-ion battery.

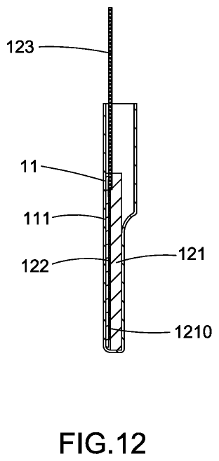

According to the present invention, the heater element 12 comprises a substrate 121 and at least a thick film layer 122 laminated on at least an attaching surface 1210 of the substrate 121. In this embodiment, as shown in FIG. 12 of the drawings, a top surface of the substrate 121 of the heater element 12 is embodied as the attaching surface 1210, the heater element 12 comprises one thick film layer 122 which is formed on the attaching surface 1210 by a silk-screen printing process.

The soldering sleeve 11 has a receiving channel 110 for receiving the heater element 12. In this embodiment, the receiving channel 110 is extended from an opening end 1101 of the soldering sleeve 11 to a closed end 1102 of the soldering sleeve 11, and the heater element 12 is fitted into the receiving channel 110 along an entire length of the soldering sleeve 11, so that the entire soldering sleeve 11 can be directly heated by the heater element 12.

More specifically, when the heater element 12 is disposed in the receiving channel 110 of the soldering sleeve 11, a tip end 1221 of the thick film layer 122 is sleeved by the closed end 1102 of the soldering sleeve 11, so that the heat from the tip end 1221 of the thick film layer 122 is transferred to the closed end 1102 of the soldering sleeve 11 which is used for heating and melting metal materials.

Accordingly, the soldering sleeve 11 comprises an inner heat transferring surface 111 which is aligned with the thick film layer 122 of the heater element 12, so that the heat from the thick film layer 122 is transferred to the inner heat transferring surface 111 of the soldering sleeve 11, and the entire soldering sleeve 11 will then be heated up to a predetermined temperature under control of the controller 21.

In this embodiment, the heater element 12 is extended into the closed end 1102 of the soldering sleeve 11, so that the closed end 1102 of the soldering sleeve 11, which is used for melting and joining metal elements can be directly heated by the heater element 12, so as to reduce the time for getting ready of the soldering sleeve 11.

The heater element 12 further comprises two electrode connecting members 123 which electrically connect the thick film layer 122 to the controller 21. Each of the two electrode connecting members 123 can be an electrical wire which is extended between the thick film layer 122 and the controller 21.

The thick film layer 122 forms an electrical heating circuit by a thick film paste which is made of solid powder doped with metal resistance paste and organic solvents, and the mixture is rolled for multiple times. The process of paste printing is carried out by a screen printer machine. The screen is strained into an aluminium frame and the thick film paste is pressed onto the carrier through it by a printing squeegee. The squeegee has constant speed and pushes the screen with contact force. The material of the screen can be stainless steel or polymer. The design of the printed layer is realized with a negative emulsion mask on polymer screens while with openings on masks.

The thick film layer 122 has a relatively low electric resistance, so that the heater element 12 can be quickly heated up for heating the soldering sleeve 11. According to the present invention, the soldering sleeve 11 can be heated to its working temperature in three to six seconds. In other words, comparing with the conventional heater core, the heating efficiency of the heater element 12 disposed in the soldering sleeve 11 is greatly enhanced. By introducing the thick film layer 122 into the heater element 12, the time for getting ready of the heating assembly 10 before the soldering operation of the portable electric soldering iron tool is significantly reduced.

The substrate 121 can be made of metal with insulation coating, or can be made of ceramics. Additional insulation layer may be further laminated on the substrate 121 to ensure the insulating performance. As examples, the substrate 121 can be made of stainless steel with an insulation layer, aluminium oxide, zirconia ceramics.

According to the present invention, the soldering sleeve 11 comprises the inner heat transferring surface 111 which is shaped and sized to couple with the attaching surface 1210 of the substrate 121, the thick film layer 122 of the heater element 12 is firmly attached to the inner heat transferring surface 111 of the soldering sleeve 11, so as to allow the heat to be quickly and efficiently transferred from the heater element 12 to the soldering sleeve 11.

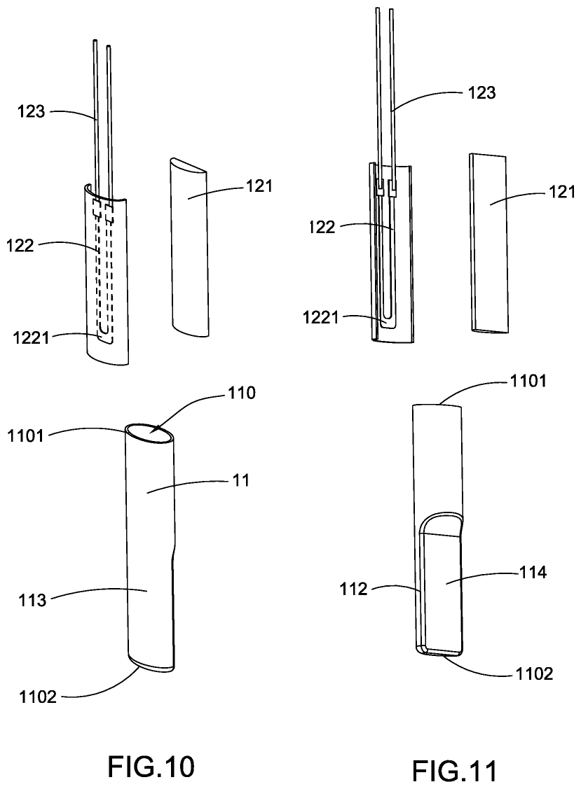

In this embodiment, as shown in FIGS. 10 to 12 of the drawings, the thick film layer 122 of the heater element 12 is illustrated to be formed on top of the substrate 121, the inner heat transferring surface 111 of the soldering sleeve 11 is the top part of the inner tubular surface of the soldering sleeve 11.

The attaching surface 1210 of the substrate 121 can be a plane surface, or an arc surface as shown in FIGS. 10 and 11 of the drawings, the thick film layer 122 of the heater element 12 also can be laminated on the arc surface of the substrate 121 and form an arc layer on the substrate, and the soldering sleeve 11 also can have an arc inner heat transferring surface 111, so as to increase the contact area between the thick film layer 122 and the soldering sleeve 11, and thus the heat transferring efficiency is further enhanced.

According to this embodiment, the closed end 1102 of the soldering sleeve 11 is a soldering end of the soldering sleeve 11 for soldering metal materials. The soldering end of the soldering sleeve 11 comprises a soldering edge 112, a top soldering surface 113 and a bottom soldering surface 114. Both of the soldering edge 112, the top soldering surface 113 and the bottom soldering surface 114 can be used for metal soldering.

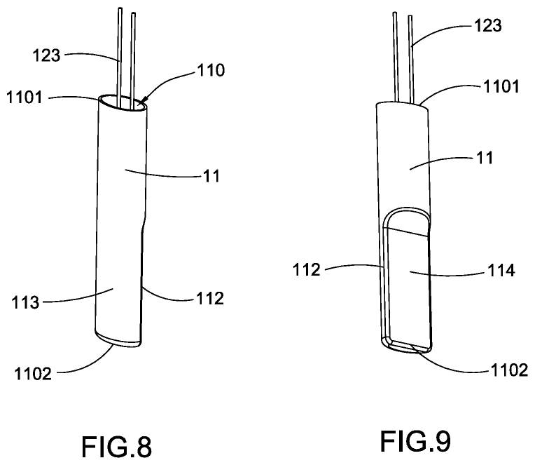

As shown in FIGS. 8 and 9 of the drawings, the soldering edge 112 is extended between the top soldering surface 113 and the bottom soldering surface 114. The top soldering surface 113 is aligned with the thick film layer 122 and the bottom soldering surface 114 is aligned with the substrate 121. Accordingly, the top soldering surface 113 can be an arc surface which is shaped to couple with the top attaching surface 1210 of the substrate 121 while the bottom soldering surface 114 can be a plane surface which is shaped to couple with the bottom surface of the substrate 121, so as to ensure the heat transferring performance while providing different soldering surface planes.

Alternatively, the top soldering surface 113 can be a plane surface which is shaped to couple with the top attaching surface 1210 of the substrate 121 while the bottom soldering surface 114 can be a plane surface which is shaped to couple with the bottom surface of the substrate 121.

The housing handle 30 comprises a handle body 31 which comprises two half bodies 311 which are assembled with each other to receive the controller 21 and the power module 23. In this embodiment, preferably, the handle body 31 i shaped like a pen, so that it is convenient for the user to hold on.

The housing handle 30 further has a sliding groove 32 for mounting the actuator 22 while allow the sliding movement of the actuator 22. Accordingly, the actuator 22 comprises a driving member 221 for being pressed to move along the sliding grove 32 and a switch member 222 for switching on or switching off the electrical connection between the controller 21 and the heater element 12. When the driving member 221 is pushed by a user to move forward, the switch member 222 is driven to slide forward, so as to switch on the electrical connection between the controller 21 and the heater element 12, and the heater element 12 is in operation to heat the soldering sleeve 11. When the driving member 221 is pushed by a user to move backward, the switch member 222 is driven to slide backward, so as to switch off the electrical connection between the controller 21 and the heater element 12, and the heating operation of heater element 12 for heating the soldering sleeve 11 is stopped.

The housing handle 30 further comprises a mounting element 33 for mounting the heating assembly 10 to the handle body 31. More specifically, the mounting element 33 comprises a mounting portion 331 which can be assembled with the handle body 31 and a retaining tube 332 allowing the heating assembly 10 to penetrate therethrough while retaining the heating assembly 10 in position. The opening end 1101 of the soldering sleeve 11 is retained in the retaining tube 332 while the closed end 1102 of the soldering sleeve 11 is protruded out of the retaining tube 332. The mounting element 33 is made of heat insulating material, so as to prevent the heat to be transferred from the soldering sleeve 11 to the housing handle 30.

In addition, the retaining tube 332 of the mounting element 33 may be made of transparent material and the control assembly 20 may comprise one or more illumination members mounted on the circuit board of the controller 21 and a light switch for turning on the illumination members, so that light beams form the illumination members can pass through the retaining tube 332 of the mounting element 33 to provide illumination during the soldering process when in dark environment.

The portable electric soldering iron tool further comprises a cap assembly 40 which comprises a cap protector 41, an auxiliary cap 42, and a retaining member 43. The cap protector 41 is detachably assembled to the handle body 31 for protecting the heating assembly 10. The auxiliary cap 42 is detachably mounted to the cap protector 41 for carrying one or more accessories. The retaining member 43 is arranged to retain the actuator 22 in position.

More specifically, the cap protector 41 comprises a protector mount 411 and a cap member 412, the protector mount 411 is arranged for detachably mounting with the handle body 31. The heating assembly 10 is inserted into the cap member 412, so that the heating assembly 10 only can be exposed when the cap protector 41 is removed from the handle body 31.

The retaining member 43 can be provided on one of the cap protector 41 and the auxiliary cap 42. In this embodiment, the retaining member 43 is integrally extended from the auxiliary cap 42. When the cap assembly 40 is assembled on the housing handle 30, the retaining member 43 is retained at a position that prevent the forward sliding movement of the actuator 22, so that the risk of accidentally actuating the heater element 12 is avoided, so as to ensure the safety use of the portable electric soldering iron tool.

The auxiliary cap 42 is detachably engaged with the cap protector 41 and is sleeved on the cap member 412 of the cap protector 41. The portable electric soldering iron tool further comprises a magnifying glass 44 and a soldering coil material 45, the magnifying glass 44 and the soldering coil material 45 can be provided on the cap protector 41 or the auxiliary cap 42. In this embodiment, the magnifying glass 44 and the soldering coil material 45 are provided on the auxiliary cap 42.

More specifically, when the auxiliary cap 42 is assembled on the cap protector 41, the soldering coil material 45 is wound around the cap member 412 of the cap protector 41. the auxiliary cap 42 has a hole 421 at an end thereof, and an end portion 451 of the soldering coil material 45 is passing through the hole 421 for retaining the soldering coil material 45 in the auxiliary cap 42. Accordingly, when there is no soldering metal material, the user can detach the soldering coil material 45 from the auxiliary cap 42 for carrying out the soldering operation.

The magnifying glass 44 comprising a connecting portion 441 and a magnifying portion 442, the connecting portion 441 is connected to the auxiliary cap 42 and the magnifying portion 442 is integrally extended from the connecting portion 441. During soldering operation, the auxiliary cap 42 can be detached and the user can hold on the auxiliary cap 42 for directing the magnifying portion 442 of the magnifying glass 44 to a desired position for facilitating the user to clearly watch the soldering position during the soldering operation.

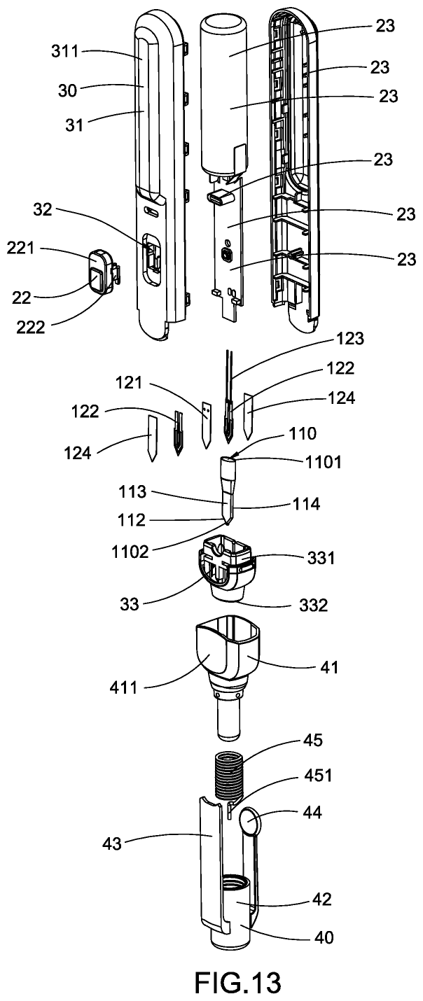

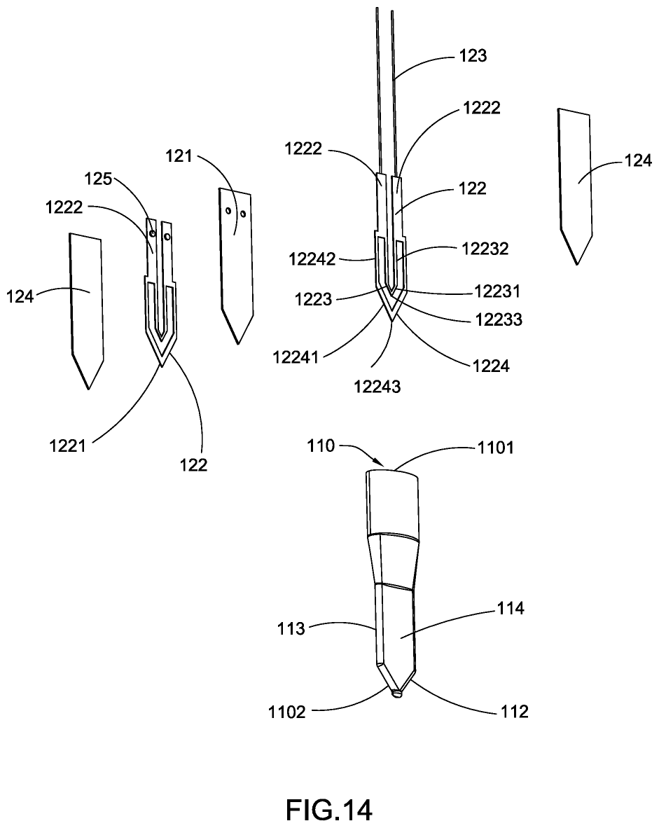

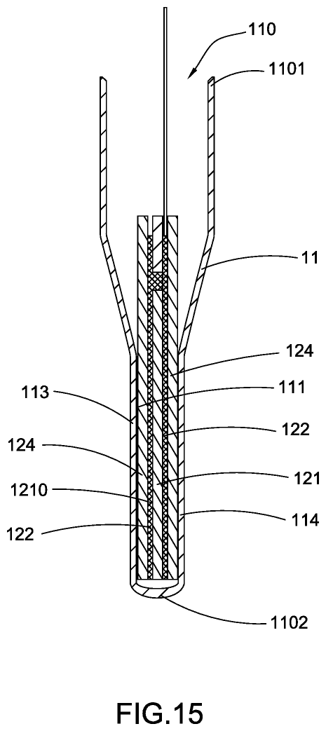

Referring to FIGS. 13 to 15 of the drawings, a portable electric soldering iron tool according to an alternative mode of the above preferred embodiment of the present invention is illustrated. Similarly, the portable electric soldering iron tool comprises the heating assembly 10, the control assembly 20 and the housing handle 30. The heating assembly 10 and the control assembly 20 are assembled to the housing handle 30 for being activated for soldering metal materials, so that the metal materials are melted and joined together.

According to the present invention, the heater element 12 comprises a substrate 121 and two thick film layers 122 laminated on two opposite attaching surfaces 1210 of the substrate 121. In other words, a top surface and a bottom surface of the substrate 121 of the heater element 12 are embodied as the attaching surfaces 1210, the heater element 12 comprises two thick film layers 122 which are respectively formed on the attaching surfaces 1210 by a silk-screen printing process.

Accordingly, the soldering sleeve 11 comprises two inner heat transferring surfaces 111 which are aligned with the two thick film layers 122 of the heater element 12, so that the heat from the thick film layers 122 are transferred to the inner heat transferring surfaces 111 of the soldering sleeve 11, and the entire soldering sleeve 11 will then be heated up to a predetermined temperature under control of the controller 21.

In this embodiment, the heater element 12 is extended into the closed end 1102 of the soldering sleeve 11, so that the closed end 1102 of the soldering sleeve 11, which is used for melting and joining metal elements can be directly heated by the two thick film layers 122 of the heater element 12, so as to reduce the time for getting ready of the soldering sleeve 11.

The heater element 12 further comprises two electrode connecting members 123 which electrically connect the thick film layer 122 to the controller 21. Each of the two electrode connecting members 123 can be an electrical wire which is extended between the thick film layer 122 and the controller 21.

Each of the thick film layers 122 comprises two electrode portions 1222, an inner heating portion 1223 and an outer heating portion 1224, the two electrode portions 1222 are respectively electrically connected to the two electrode connecting members 123, the inner heating portion 1223 and the outer heating portion 1224 are respectively electrically connected to the two electrode portions 1222 in a parallel connection manner. The inner heating portion 1223 and the outer heating portion 1224 are arranged to enhance the heating performance of the heater element 12, so as to quickly heat the soldering sleeve 11 to the working temperature.

Accordingly, one of the two thick film layers 122 is electrically connected to the two electrode connecting members 123, the other thick film layer 122 may be electrically connected to the two electrode connecting members 123 by two connectors 125 penetrating through the substrate 121.

The inner heating portion 1223 comprises two inner tip end portions 12231 and two inner extending portions 12232, the two inner tip end portions 12231 are joined to form an inner tip 12233 of the inner heating portion 1223, the two inner extending portions 12232 are respectively extended from the two electrode portions 1222.

The outer heating portion 1224 comprises two outer tip end portions 12241 and two outer extending portions 12242, the two outer tip end portions 12331 are joined to form an outer tip 12243 of the outer heating portion 1224, the two outer extending portions 12242 are respectively extended from the two electrode portions 1222.

In this embodiment, the heater element 12 may further comprises a protection layer 124 which is attached on each of the thick film layers 122. The protection layer 12 can be embodied as a transparent glaze layer.

According to the present invention, the soldering sleeve 11 comprises the inner heat transferring surfaces 111 which are shaped and sized to couple with the attaching surfaces 1210 of the substrate 121, the thick film layers 122 of the heater element 12 are firmly attached to the two inner heat transferring surfaces 111 of the soldering sleeve 11, so as to allow the heat to be quickly and efficiently transferred from the heater element 12 to the soldering sleeve 11.

In this embodiment, the attaching surfaces 1210 of the substrate 121 can be a plane surface, the thick film layers 122 of the heater element 12 also can be laminated on the plane surfaces of the substrate 121, and the soldering sleeve 11 also can have an inner plane heat transferring surface 111, and the heat transferring efficiency is enhanced.

According to this embodiment, the closed end 1102 of the soldering sleeve 11 is a soldering end of the soldering sleeve 11 for soldering metal materials. The soldering end of the soldering sleeve 11 comprises a soldering edge 112, a top soldering surface 113 and a bottom soldering surface 114. Both of the soldering edge 112, the top soldering surface 113 and the bottom soldering surface 114 which are planes surfaces can be used for metal soldering.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A portable electric soldering iron tool, comprising:
a heating assembly which comprises a soldering sleeve and a heater element disposed in said soldering sleeve, wherein said heater element comprises a substrate and at least a thick film layer provided on said substrate;
a control assembly which comprises a controller and a power module electrically connected to said controller, wherein said thick film layer of said heater element is electrically connected to said controller; and
a housing handle, wherein said heating assembly and said control assembly are assembled to said housing handle.

2. The portable electric soldering iron tool according to claim 1, wherein said substrate comprise an attaching surface, wherein said soldering sleeve comprises an inner heat transferring surface which is shaped and sized to couple with said attaching surface of said substrate, so as to allow said thick film layer sandwiched between said attaching surface of said substrate and said inner heat transferring surface of said soldering sleeve to have a firmly contact with said soldering sleeve.

3. The portable electric soldering iron tool according to claim 2, wherein said attaching surface of said substrate is an arc surface, wherein said inner heat transferring surface of said soldering sleeve is an arc surface which is shaped and sized to couple with said attaching surface of said substrate.

4. The portable electric soldering iron tool according to claim 2, wherein said attaching surface of said substrate is a plane surface, wherein said inner heat transferring surface of said soldering sleeve is a plane surface which is shaped and sized to couple with said attaching surface of said substrate.

5. The portable electric soldering iron tool according to claim 1, wherein said heater element comprises two said thick film layers provided on two sides of said substrate.

6. The portable electric soldering iron tool according to claim 5, wherein said substrate comprise two attaching surfaces which are opposite to each other, wherein said soldering sleeve comprises two inner heat transferring surfaces which are respectively shaped and sized to couple with said two attaching surfaces of said substrate.

7. The portable electric soldering iron tool according to claim 5, wherein said heater element further comprises two electrode connecting members electrically connecting said thick film layer to said controller, each of two said thick film layers comprises two electrode portions electrically connected to said two electrode connecting members respectively, one or more heating portions connected to said two electrode portions.

8. The portable electric soldering iron tool according to claim 7, wherein each of two said thick film layers comprises an inner heating portion and an outer heating portion which are respectively connected to said two electrode portions and are arranged in a parallel connection manner.

9. The portable electric soldering iron tool according to claim 8, wherein each of two said inner heating portion and said outer heating portion comprises two tip end portions and two extending portions, wherein said two tip end portions, which are respectively extended from said two extending portions, are joined to form a tip end.

10. The portable electric soldering iron tool according to claim 1, wherein said soldering sleeve comprises an opening end and a closed end, wherein said heater element is inserted into said soldering sleeve through said opening end, wherein said thick film layer is inserted to a position corresponding to said closed end of said soldering sleeve.

11. The portable electric soldering iron tool according to claim 2, wherein said soldering sleeve comprises an opening end and a closed end, wherein said heater element is inserted into said soldering sleeve through said opening end, wherein said thick film layer is inserted to a position corresponding to said closed end of said soldering sleeve.

12. The portable electric soldering iron tool according to claim 5, wherein said soldering sleeve comprises an opening end and a closed end, wherein said heater element is inserted into said soldering sleeve through said opening end, wherein said thick film layer is inserted to a position corresponding to said closed end of said soldering sleeve.

13. The portable electric soldering iron tool according to claim 1, wherein said control assembly comprises an actuator which comprises a driving member and a switch member, wherein said housing handle has a sliding groove, wherein said driving member is disposed at said sliding groove, wherein said driving member is arranged to be operated to slide along said sliding groove to drive said switch member to switch on or switch off an electrical connection between said controller and said heater element.

14. The portable electric soldering iron tool according to claim 13, further comprising a cap assembly detachably mounted to said housing handle, wherein said cap assembly comprises a retaining member which is arranged to block sliding movement of said driving member of said actuator when said cap assembly is assembled to said housing handle, wherein when said cap assembly is detached from said housing handle, the sliding movement of said actuator is allowed.

15. The portable electric soldering iron tool according to claim 14, wherein said cap assembly comprises a cap protector and an auxiliary cap, wherein said cap protector is detachably mounted to said housing handle, said auxiliary cap is detachably mounted to said cap protector, wherein said retaining member is connected to one of said cap protector and said auxiliary cap.

16. The portable electric soldering iron tool according to claim 15, wherein said cap protector comprises a protector mount which is detachably mounted to said housing handle and a cap member connected to said protector mount to receive said heating assembly.

17. The portable electric soldering iron tool according to claim 15, further comprising a magnifying glass which is connected to one of said cap protector and said auxiliary cap.

18. The portable electric soldering iron tool according to claim 15, further comprising a soldering coil material which is detachably connected to said auxiliary cap.

19. The portable electric soldering iron tool according to claim 1, wherein said housing handle comprises a handle body for receiving said controller, a mounting element assembled to said handle body for mounting said heating assembly.

20. The portable electric soldering iron tool according to claim 19, wherein said mounting element comprises a mounting portion mounted to said handle body and a retaining tube connected to said mounting portion to mount said soldering sleeve in position, wherein said soldering sleeve comprises an opening end and a closed end, wherein said opening end of said soldering sleeve is retained in said retaining tube, said closed end of said soldering sleeve is extended at an outer side of said retaining tube.
